(19) United States
(12) Patent Application Publication
(10) Pub. No.: US 2024/0119274 A1
(43) Pub. Date: Apr. 11, 2024

(54) TRAINING NEURAL NETWORKS WITH CONVERGENCE TO A GLOBAL MINIMUM

(71) Applicant: International Business Machines Corporation, Armonk, NY (US)

(72) Inventor: Lam Minh Nguyen, Ossining, NY (US)

(21) Appl. No.: 17/951,587

(22) Filed: Sep. 23, 2022

(51) Int. Cl. G06N 3/08

(52) U.S. Cl. CPC G06N 3/08

(57) ABSTRACT

Select an initial weight vector for a convex optimization sub-problem associated with a neural network having a non-convex network architecture loss surface. With at least one processor, approximate a solution to the convex optimization sub-problem that obtains a search direction, to learn a common classifier from training data. With the at least one processor, update the initial weight vector by subtracting the approximate solution to the convex optimization sub-problem times a first learning rate. With the at least one processor, repeat the approximating and updating steps, for a plurality of iterations, with the updated weight vector from a given one of the iterations taken as the initial weight vector for a next one of the iterations, to obtain a final weight vector for the neural network, until convergence to a global minimum is achieved, to implement the common classifier.

### STATEMENT REGARDING PRIOR DISCLOSURES BY THE INVENTOR OR A JOINT INVENTOR

The following disclosure(s) are submitted under 35 U.S.C. 102(b)(1)(A):
Lam M. Nguyen, Trang H. Tran, Marten van Dijk, New Perspective on the Global Convergence of Finite-Sum Optimization, alternate title Finite-Sum Optimization: A New Perspective for Convergence to a Global Solution, Submitted online to ICLR 2022 28 Sep. 2021 (version 1 imported: 3 Oct. 2021).
Lam M. Nguyen, Trang H. Tran, Marten van Dijk, New Perspective on the Global Convergence of Finite-Sum Optimization, alternate title Finite-Sum Optimization: A New Perspective for Convergence to a Global Solution, Submitted online to ICLR 2022 28 Sep. 2021 (version 2 imported: 16 Nov. 2021).
Lam M. Nguyen, Trang H. Tran, Marten van Dijk, New Perspective on the Global Convergence of Finite-Sum Optimization, alternate title Finite-Sum Optimization: A New Perspective for Convergence to a Global Solution, Submitted online to ICLR 2022 28 Sep. 2021 (version 3 imported: 21 Nov. 2021).

### BACKGROUND

The present invention relates generally to the electrical, electronic and computer arts and, more particularly, to training neural networks, including, but not limited to, deep neural networks.

Neural networks, also known as artificial neural networks (ANNs) or simulated neural networks (SNNs), are a subset of machine learning and are at the heart of deep learning algorithms. Artificial neural networks (ANNs) include layers of nodes, containing an input layer, one or more hidden layers, and an output layer. Each node, or artificial neuron, connects to one or more other nodes and has an associated weight and threshold. If the output of any individual node is above the specified threshold value, that node Is activated, sending data to the next layer of the network. Otherwise, no data is passed along to the next layer of the network.

A deep neural network (DNN) is an ANN with multiple hidden layers between the input and output layers. DNNs have shown great success in many machine learning tasks. Their training is challenging, since the loss surface of the network architecture is generally non-convex. How, and under what assumptions, it is guaranteed to converge to a global minimum is an important aspect of deep neural network training.

### BRIEF SUMMARY

Principles of the invention provide a framework for training neural networks (e.g., deep neural networks). In one aspect, an exemplary method includes the steps of selecting an initial weight vector for a convex optimization sub-problem associated with a neural network having a non-convex network architecture loss surface; with at least one processor, approximating a solution to the convex optimization sub-problem that obtains a search direction, to learn a common classifier from training data; with the at least one processor, updating the initial weight vector by subtracting the approximate solution to the convex optimization sub-problem times a first learning rate; and, with the at least one processor, repeating the approximating and updating steps, for a plurality of iterations, with the updated weight vector from a given one of the iterations taken as the initial weight vector for a next one of the iterations, to obtain a final weight vector for the neural network, until convergence to a global minimum is achieved, to implement the common classifier.

In another aspect, an exemplary computer program product includes a computer readable storage medium having program instructions embodied therewith; the program instructions are executable by a processor to cause the processor to: obtain a selection of an initial weight vector for a convex optimization sub-problem associated with a neural network having a non-convex network architecture loss surface; approximate a solution to the convex optimization sub-problem that obtains a search direction, to learn a common classifier from training data; update the initial weight vector by subtracting the approximate solution to the convex optimization sub-problem times a first learning rate; and repeat the approximating and updating steps, for a plurality of iterations, with the updated weight vector from a given one of the iterations taken as the initial weight vector for a next one of the iterations, to obtain a final weight vector for the neural network, until convergence to a global minimum is achieved, to implement the common classifier.

In still another aspect, an exemplary apparatus includes a memory; and at least one processor, coupled to the memory, and operative to: obtain a selection of an initial weight vector for a convex optimization sub-problem associated with a neural network having a non-convex network architecture loss surface; approximate a solution to the convex optimization sub-problem that obtains a search direction, to learn a common classifier from training data; update the initial weight vector by subtracting the approximate solution to the convex optimization sub-problem times a first learning rate; and repeat the approximating and updating steps, for a plurality of iterations, with the updated weight vector from a given one of the iterations taken as the initial weight vector for a next one of the iterations, to obtain a final weight vector for the neural network, until convergence to a global minimum is achieved, to implement the common classifier.

As used herein, “facilitating” an action includes performing the action, making the action easier, helping to carry the action out, or causing the action to be performed. Thus, by way of example and not limitation, instructions executing on a processor might facilitate an action carried out by another processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
a framework for training deep learning problems using gradient information;
algorithms based on a new representation of the empirical risk minimization problem which takes the advantage of the structure of machine learning tasks;
new update rule based on solving convex quadratic subproblems;
a convergence guarantee for finding a global solution of the empirical risk minimization problems;
a framework that includes a new representation of the empirical risk minimization problem;
an update rule based on solving convex quadratic subproblems for a non-convex problem;
guaranteed convergence of the non-convex problem to a global solution, which is superior to local solutions;
ability to re-formulate a non-convex general problem (even highly non-convex) into a convex subproblem;
improve the technological process of computerized machine learning in that models trained in accordance with aspects of the invention provide improved inferencing accuracy as a result of an improved training method based on the obtained global solution, especially for highly non-convex problems, for which prior-art techniques have provided only local solutions; and
techniques applicable to well-known tasks in deep learning problems, including classification and regression with softmax cross entropy loss and mean squared loss, respectively.

Some embodiments may not have these potential advantages and these potential advantages are not necessarily required of all embodiments. These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of a deep learning system, according to an aspect of the invention;

FIG. 2 illustrates a comparison of Algorithm 1 (an algorithm according to an aspect of the invention) versus gradient descent (GD) and Stochastic Gradient Method (SGD) algorithms, in accordance with an example embodiment; and

FIG. 3 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

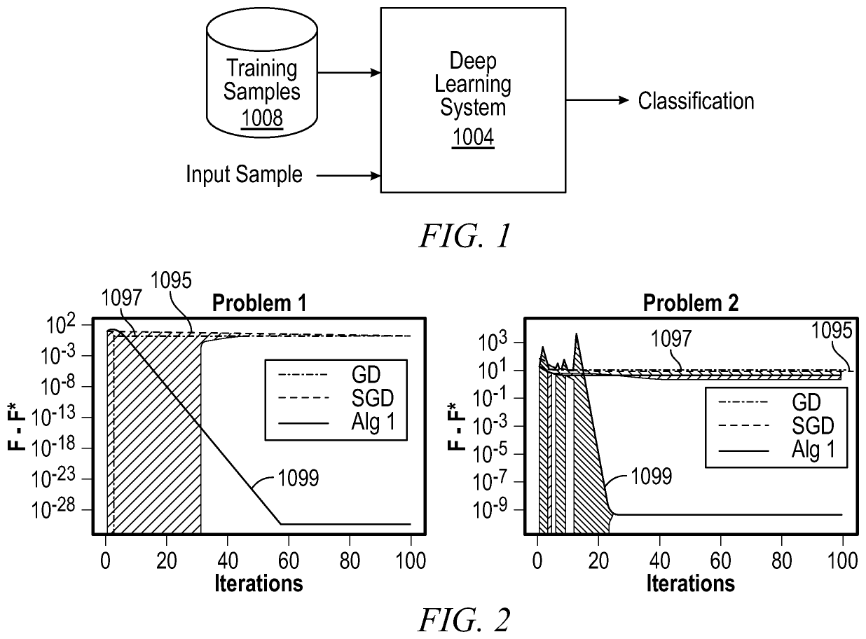

FIG. 1 is a block diagram of a deep learning system 1004. In many supervised learning tasks, training data [symbol] ₙ={(x₁, y₁), . . . , (xₙ, yₙ)}, such as training samples 1008, is provided, which represents an underlying distribution. One well-known goal is to learn a predictive model h_{w}(x) from the data. Once trained, the deep learning system 1004 processes an input sample and generates a classification result that classifies the input sample based on the training. Non-limiting examples for h_{w}(x) include:
Linear regression: h(x)=w^{T}x
Logistic regression: h(x)=1/1+exp(−w^{T}x)

It is noted that a non-convex optimization problem will typically include at least one local minimum in addition to a global minimum (i.e., global solution). First order methods, such as the Gradient Descent Method, the Stochastic Gradient Method (SGD) and its variants, and Variance Reduction Methods (SAG/SAGA, SVRG, SARAH) cannot guarantee convergence to a global solution for general non-convex problems.

To learn the model parameter w, empirical risk minimization is the most widely-used optimization framework:

$$w = arg min \frac{1}{n} {\sum }_{i = 1}^{n} ℓ ( h ( {x}_{i} ; w ) , {y}_{i} )$$

In one example embodiment, an efficient optimization framework is provided for solving the empirical risk minimization. The disclosed techniques may be applied to computer vision, natural language processing, and the like. In one example embodiment, the framework for training deep learning problems uses gradient information. Algorithms based on a new representation of the empirical risk minimization problem which take advantage of the structure of machine learning tasks are introduced. In one example embodiment, an update rule based on solving convex quadratic subproblems is introduced. The techniques provide a convergence guarantee for finding a global solution of the empirical risk minimization problems and are applicable to well-known tasks in deep learning problems, including classification and regression with softmax cross entropy loss and mean squared loss, respectively.

Generally, a reformulation of the minimization problem allowing for a new recursive algorithmic framework is disclosed. The disclosed framework takes advantage of the structure of machine learning tasks by considering a new representation of the empirical risk minimization problem. An update rule based on solving convex quadratic subproblems to obtain a global solution for a non-convex problem is disclosed. Guaranteed convergence to a global solution of the non-convex problem is attained. In a non-limiting example, the framework and related algorithms are implemented in software on a general-purpose computer, such as a powerful general purpose computer (e.g., including graphical processing units and the like). For example, code the logic and solutions to the mathematical equations herein in a high-level language, compile or interpret into machine-executable code, and implement on one or more hardware processors. Hardware acceleration could be employed in some instances.

By using bounded style assumptions, convergence to an ε-(global) minimum using [symbol] (1/ε³) gradient computations is proven. The disclosed theoretical foundation motivates further implementation and optimization of the new algorithmic framework and investigation of its non-standard bounded style assumptions. This new direction broadens the understanding of why, and under what circumstances, training of a DNN converges to a global minimum.

In recent years, deep neural networks (DNNs) have shown great success in many machine learning tasks. Training these neural networks is challenging, since the loss surface of network architecture is generally non-convex. Thus, there has been a long-standing question on how optimization algorithms may converge to a global minimum. Many previous works have investigated the Gradient Descent algorithm and its stochastic version for the over-parameterized setting. Although these works have shown promising convergence results under certain assumptions, there is still a lack of new efficient methods that can guarantee convergence to a global solution for machine learning optimization. In one example embodiment, instead of analyzing the traditional finite-sum formulation, a new composite formulation is adopted that exactly depicts the structure of machine learning where a data set is used to learn a common classifier.

### Representation

Let {x⁽ⁱ⁾, y⁽ⁱ⁾}ᵢ₌₁ⁿ be a given training set with x⁽ⁱ⁾ ∈ [symbol] ^{m},y⁽ⁱ⁾ ∈ [symbol] ^{c}. The following representation for deep learning tasks is considered:

$${min}_{w ∈ {ℝ}^{d}} \{ F ( w ) = \frac{1}{n} {\sum }_{i = 1}^{n} {ϕ}_{i} ( h ( w ; i ) ) \} , \qquad ( 1 )$$

where h(⋅;i): [symbol] ^{d}→ [symbol] ^{c},i ∈ [n]={1, . . . , n}, is the classifier for each data point x⁽ⁱ⁾; and ϕᵢ: [symbol] ^{c}→ [symbol] , i ∈ [n], is the loss function corresponding to each output y⁽ⁱ⁾. The composite formulation (1) is a special case of the finite-sum minimization problem

$${min}_{w ∈ {ℝ}^{d}} \{ F ( w ) = \frac{1}{n} {\sum }_{i = 1}^{n} f ( w ; i ) \}$$

where each individual function f(⋅;i) is a composition of the loss function ϕᵢ and the classifier h(⋅;i). This problem covers various important applications in machine learning, including logistic regression and neural networks. The most common approach for the finite-sum problem is using first-order methods, such as (stochastic) gradient algorithms, and making assumptions on the component functions f(⋅;i). As an alternative, the structure of the loss function ϕᵢ is considered and an assumption is narrowed on the classifier h(⋅;i). For the purpose of this disclosure, convex and Lipschitz-smooth loss functions are first considered while the classifiers can be non-convex. Using this representation, a new framework is introduced followed by two algorithms that guarantee convergence to a global solution for the minimization problem.

### Algorithmic Framework

Representation (1) admits a new perspective. One pertinent insight is to (A) define zᵢ^{(t)}=h(w^{(t)};i), where t is an iteration count of the outer loop in the disclosed algorithmic framework. Next (B), the change zᵢ^{(t+1)}−zᵢ^{(t)} is to be approximated in terms of a step size times the gradient

$$∇ {ϕ}_{i} ( {z}_{i}^{( t )} ) = {( \frac{\partial {ϕ}_{i} ( z )}{\partial {z}_{a}} )}_{a ∈ ⌈ c ⌉} {\vert}_{z = {z}_{i}^{( t )}} ,$$

and (C) the change h(w^{(t+1)};i)−h(w^{(t)};i) is approximated in terms of the first order derivative

$${H}_{i}^{( t )} = {( \frac{\partial {h}_{a} ( w ; i )}{\partial {w}_{b}} )}_{a ∈ ⌈ c ⌉ , b ∈ ⌈ d ⌉} {\vert}_{w = {w}^{( t )}} .$$

Finally, (A), (B), and (C) are combined to equate the approximations of zᵢ^{(t+1)}−zᵢ^{(t)} and h(w^{(t+1)};i)−h(w^{(t)};i). This leads to a recurrence w^{(t)} of the form w^{(t+1)}=w^{(t)}−η^{(t)}v^{(t)}, where η^{(t)} is a step size and which involves computing v^{(t)} by solving a convex quadratic subproblem, see the details in section below entitled New Algorithm Framework. Two methods for approximating a solution for the derived subproblem are described below. It is shown how to approximate the subproblem by transforming it into a strongly convex problem by adding a regularizer which can be solved in closed form. It is shown how to use Gradient Descent (GD) on the subproblem to find an approximation κ^{(t)} of its solution.

### Convergence Analysis

The disclosed analysis introduces non-standard bounded style assumptions. Intuitively, it is assumed that the convex and quadratic subproblem has a bounded solution. This allows the proof of a total complexity of

$$\tilde{𝒪} ( \frac{1}{{ε}^{3}} )$$

to find an ε-(global) solution that satisfies F(ŵ)−F_{*}≤ε, where F_{*} is the global minimizer of F. The analysis applies to a wide range of applications in machine learning: the results hold for squared loss and softmax cross-entropy loss and are applicable for a range of activation functions in DNN, as it is only assumed that the h(⋅;i) are twice continuously differentiable and their Hessian matrices (second order derivatives) as well as their gradients (first order derivatives) are bounded.

### Outline

In one example embodiment, a representation (1) for analyzing the machine learning minimization problem is introduced. The formulation utilizes the structure of machine learning tasks where a training data set of inputs and outputs is used to learn a common classifier. Based on the disclosed representation, a novel algorithm framework is disclosed. The algorithmic framework approximates a solution to a subproblem for which two distinct approaches are described.

For general DNNs, and based on bounded style assumptions, a total complexity of

$$\tilde{𝒪} ( \frac{1}{{ε}^{3}} )$$

is proven to find an ε-(global) solution that satisfies F(ŵ)−F_{*}≤ε, where F_{*} is the global minimizer of F.

It is worth noting that, generally, input data can be an image or vector. The number of input data refers to the set of data for training. For example, if using 10,000 images to train, then the number of input data=10,000.

### Formulations and Notations

In this section, the formulation and notations are described in detail. The disclosed framework and theoretical analysis are general and applicable for many learning architectures. Recalling that

$$F ( w ) = \frac{1}{n} {\sum }_{i = 1}^{n} {ϕ}_{i} ( h ( w ; i ) ) ,$$

where h(⋅;i): [symbol] ^{d}→ [symbol] ^{c},i ∈ [n]={1, . . . , n}, is the classifier for each input data point x⁽ⁱ⁾; and ϕᵢ: [symbol] ^{c}→ [symbol] ,i ∈ [n] is the loss function corresponding to each output y⁽ⁱ⁾, for j ∈ [c],hⱼ(⋅;i): [symbol] ^{d}→ [symbol] denotes the component function of the output h(⋅;i), for each data point i ∈ [n] respectively. Moreover, it is defined that h*ᵢ= [symbol] , i ∈ [n]. The well-known loss functions in neural networks for solving classification and regression problems are softmax cross-entropy loss and square loss, respectively:

$$( Softmax Cross - Entropy Loss : F ( w ) = \frac{1}{n} {\sum }_{i = 1}^{n} f ( w ; i ) with \qquad ( 2 )$$

$$f ( w ; i ) = - {y}^{( i ) T} log ( softmax ( h ( w ; i ) ) ) .$$

$$Squared Loss : F ( w ) = \frac{1}{n} {\sum }_{i = 1}^{n} f ( w ; i ) with \qquad ( 3 )$$

$$f ( w ; i ) = \frac{1}{2} {‖ h ( w ; i ) - {y}^{( i )} ‖}^{2} .$$

Some basic definitions in optimization theory to support the disclosed theory are presented below. Definition 1 (L-smooth). Function ϕ: [symbol] ^{c}→ [symbol] is L_{ϕ}-smooth if there exists a constant L_{ϕ}>0 such that, ∀x₁,x₂ ∈ [symbol] ^{c},

∥∇ϕ(x₁)−∇ϕ(x₂)∥≤L_{ϕ}∥x₁−x₂∥. (4)

Definition 2 (Convex). Function ϕ: [symbol] ^{c}→ [symbol] is convex if ∀x₁,x₂ ∈ [symbol] ^{c},

ϕ(x₁)−ϕ(x₂)≥ [symbol] ∇ϕ(x₂),x₁−x₂ [symbol] . (5)

The following corollary shows the properties of softmax cross-entropy loss (2) and squared loss (3).

### Corollary 1

For softmax cross-entropy loss (2) and squared loss (3), there exist functions h(⋅;i): [symbol] ^{d}→ [symbol] ^{c} and ϕᵢ: [symbol] ^{c}→ [symbol] such that, for i ∈ [n], ϕᵢ(z) is convex and L_{ϕ}-smooth with L_{ϕ}=1, and

f(w;i)=ϕᵢ(h(w;i))=ϕᵢ(z)|_{z=h(w;i}). (6)

### New Algorithm Framework

### Pertinent Insight

It is assumed f(w;i)=ϕᵢ(h(w;i)) with ϕᵢ convex and L_{ϕ}-smooth. One goal is to utilize the convexity of the outer function ϕᵢ. In order to simplify notation, it is written ∇_{z}ϕᵢ(h(w^{(t)};i)) instead of ∇_{z}ϕᵢ(z)|_{z=h(w}_{^{(t)}}_{;i)} and denoted zᵢ^{(t)}=h(w^{(t)};i). Starting from the current weight w^{(t)}, it is desirable to find the next point w^{(t+1)} that satisfies the following approximation for all i ∈ [n]:

h(w^{(t+1)};i)=zᵢ^{(t+1)}≈zᵢ^{(t)}−αᵢ^{(t)}∇_{z}ϕᵢ(zᵢ^{(t)})=h(w^{(t)};i)−αᵢ^{(t)}∇_{z}ϕᵢ(h(w^{(t)};i). (7)

It can be seen that this approximation is a “noisy” version of a gradient descent update for every function ϕᵢ, simultaneously for all i ∈ [n]. In order to do this, the following update is used in one or more embodiments:

w^{(t+1)}=w^{(t)}−η^{(t)}v^{(t)}, (8)

where η^{(t)}>0 is a learning rate and v^{(t)} is a search direction that helps approximate equation (7). If the update term η^{(t)}v^{(t)} is small enough, and if h(⋅; i) has some nice smooth properties, then from basic calculus the following approximation is derived:

h(w^{(t+1)};i)=h(w^{(t)}−η^{(t)}v^{(t)};i)≈h(w^{(t)};i)−Hᵢ^{(t)}(η^{(t)}v^{(t)}). (9)

where Hᵢ^{(t)} is a matrix in [symbol] ^{cxd} with first-order derivatives. Motivated by approximations (7) and (9), the following optimization problem is considered:

$${v}_{*}^{( t )} = arg {min}_{v ∈ {ℝ}^{d}} \{ \frac{1}{2} \frac{1}{n} {\sum }_{i = 1}^{n} {‖ {H}_{i}^{( t )} ( {η}^{( t )} v ) - {α}_{i}^{( t )} {∇}_{z} {ϕ}_{i} ( h ( {w}^{( t )} ; i ) ) ‖}^{2} \} . \qquad ( 10 )$$

Hence, by solving for the solution v_{*}^{(t)} of problem (10), a search direction can be found for the key approximation (7). This yields the algorithmic Framework 1, as described more fully below.

### Framework 1: Algorithm Framework

Initialization: Choose an initial point w⁽⁰⁾ ∈ [symbol] ^{d};
for t=0, 1, . . . , T-1 do
   Solve for an approximation v^{(t)} of the solution v_{*}^{(t)} of the problem in (10)

$${v}_{*}^{( t )} = arg {min}_{v ∈ {ℝ}^{d}} \{ \frac{1}{2} \frac{1}{n} {\sum }_{i = 1}^{n} {‖ {η}^{( t )} {H}_{i}^{( t )} v - {α}_{i}^{( t )} {∇}_{z} {ϕ}_{i} ( h ( {w}^{( t )} ; i ) ) ‖}^{2} \} .$$

Update w^{(t+1)}=w^{(t)}−η^{(t)}v^{(t)}
end for

### Technical Assumptions

Assumption 1: The loss function ϕᵢ is convex and L_{ϕ}-smooth for i ∈ [n]. Moreover, it is assumed that it is lower bounded, i.e., [symbol] >−∞ for i ∈ [n].

The convexity and smoothness of squared loss and softmax cross-entropy loss was shown in the section entitled Formulations and Notations. The bounded property of ϕᵢ is required in any algorithm for the well-definedness of (1). Now, in order to use the Taylor series approximation, the following assumption on the neural network architecture h is needed:

Assumption 2: It is assumed that h(⋅; i) is twice continuously differentiable for all i ∈ [n] (i.e. the second-order partial derivatives of all scalars hⱼ(⋅; i) are continuous for all j ∈ [c] and i ∈ [n]), and that their Hessian matrices are bounded, that is, there exists a G>0 such that for all w ∈ [symbol] ^{d}, i 531 [n] and j ∈ [c],

∥M_{i,j}(w)∥=∥J_{w}(∇_{w}(w; i))∥≤G, (11)

where J_{w} denotes the Jacobian. (For a continuously differentiable function g(w): [symbol] ^{d}→ [symbol] ^{c} we define the Jacobian J_{w}(g(w)) as the matrix (∂gₐ(w)/∂w_{b})_{a∈[c],b∈[d]}.

Assumption 2 allows the application of a Taylor approximation of each function hⱼ(⋅; i) with which the following Lemma that bounds the error in equation (9) is proven:

Lemma 1: Suppose that Assumption 2 holds for the classifier h. Then for all i ∈ [n] and 0≤t<T,

h(w^{(t+1)};i)=h(w^{(t)}−η^{(t)}v^{(t)};i)=h(w^{(t)};i)−η^{(t)}Hᵢ^{(t)}v^{(t)}+ϵᵢ^{(t)}. (12)

where Hᵢ^{(t)}=J_{w}(h(W; i))|_{w=w}_{^{(t)}} ∈ [symbol] ^{cxd} is defined as the Jacobian matrix of h(w; i) at w^{(t)} and entries ϵ_{i,j}^{(t)}, j ∈ [c] of vector ϵᵢ^{(t)} satisfy

|ϵ_{i,j}^{(t)}|≤½(η^{(t)})²∥v^{(t)}∥²G. (13)

In order to approximate (7) combined with (9), that is, to make sure the right-hand sides of (7) and (9) are close to one another, the optimization problem (10) is considered:

$${v}_{*}^{( t )} = arg {min}_{v ∈ {ℝ}^{d}} \{ \frac{1}{2} \frac{1}{n} {\sum }_{i = 1}^{n} {‖ {η}^{( t )} {H}_{i}^{( t )} v - {α}_{i}^{( t )} {∇}_{z} {ϕ}_{i} ( h ( {w}^{( t )} ; i ) ) ‖}^{2} \} .$$

The optimal value of problem (10) is equal to 0 if there exists a vector v^{(t)} satisfying η^{(t)}Hᵢ^{(t)}v_{*}^{(t)}=αᵢ^{(t)}∇_{z}ϕᵢ(h(w^{(t)};i)) for every i ∈ [n]. Since the solution v_{*}^{(t)} is in [symbol] ^{d} and ∇_{z}ϕᵢ(h(w^{(t)};i)) is in [symbol] ^{c}, this condition is equivalent to a linear system with n·c constraints and d variables. In the over-parameterized setting where dimension d is sufficiently large (d»n·c) and there are no identical data, there exists almost surely a vector v_{*}^{(t)} that interpolates all the training set.

Note that an approximation of v_{*}^{(t)} serves as the search direction for Framework 1. For this reason, the solution v_{*}^{(t)} of problem (10) plays a similar role as a gradient in the search direction of the (stochastic) gradient descent method. It is standard to assume a bounded gradient in the machine learning literature. Accordingly, the following Assumption 3 is assumed, which implies the existence of a near-optimal bounded solution of (10):

Assumption 3: An over-parameterized setting is considered, where dimension d is sufficiently large to interpolate all the data and the tolerance ε. It is assumed that there exists a bound V>0 such that for ε>0 and 0≤t<T as in Framework 1, there exists a vector \hat{v}_{*ε}^{(t)} with ∥\hat{v}_{*ε}^{(t)}∥²≤V so that

$$\frac{1}{2} \frac{1}{n} {\sum }_{i = 1}^{N} {‖ {η}^{( t )} {H}_{i}^{( t )} {\hat{v}}_{* ε}^{( t )} - {α}_{i}^{( t )} {∇}_{z} {ϕ}_{i} ( h ( {w}^{( t )} ; i ) ) ‖}^{2} \leq {ε}^{2} .$$

Consider the tolerance ε for the gradient matrices Hᵢ^{(t)} and ∇_{z}ϕᵢ(h(w^{(t)};i)). It is noted that, at the starting point t=0, these matrices may depend on ε due to the initialization process and the dependence of d on ε.

### New Algorithms and Convergence Results

### Approximating the Solution Using Regularizer

Since problem (10) is convex and quadratic, the following regularized problem is

considered:

$${min}_{v ∈ {ℝ}^{d}} \{ {Ψ}^{( t )} ( v ) = {Φ}^{( t )} ( v ) + \frac{{ε}^{2}}{2} {‖ v ‖}^{2} = \frac{1}{2} \frac{1}{n} {\sum }_{i = 1}^{n} {‖ {η}^{( t )} {H}_{i}^{( t )} v - {α}_{i}^{( t )} {∇}_{z} {ϕ}_{i} ( h ( {w}^{( t )} ; i ) ) ‖}^{2} + \frac{{ε}^{2}}{2} {‖ v ‖}^{2} \} , \qquad ( 14 )$$

for some small ε>0 and t≥0. Problem (14) is strongly convex, and has a unique minimizer v_{*reg}^{(t)}. The global minimizer satisfies ∇ᵥΨ^{(t)}(v_{*reg}^{(t)})=0. Therefore,

$${∇}_{v} {Ψ}^{( t )} ( v ) = \frac{1}{n} {\sum }_{i = 1}^{n} [ {η}^{( t )} {H}_{i}^{( t ) T} {H}_{i}^{( t )} {η}^{( t )} v - {α}_{i}^{( t )} {η}^{( t )} {H}_{i}^{( t ) T} {∇}_{z} {ϕ}_{i} ( h ( {w}^{( t )} ; i ) ) ] + {ε}^{2} \cdot v = ( \frac{1}{n} {\sum }_{i = 1}^{n} {η}^{( t )} {H}_{i}^{( t ) T} {H}_{i}^{( t )} {η}^{( t )} + {ε}^{2} I ) v - ( \frac{1}{n} {\sum }_{i = 1}^{n} {α}_{i}^{( t )} {η}^{( t )} {H}_{i}^{( t ) T} {∇}_{z} {ϕ}_{i} ( h ( {w}^{( t )} ; i ) ) ) .$$

Therefore,

$${v}_{* reg}^{( t )} = {( \frac{1}{n} {\sum }_{i = 1}^{n} {η}^{( t )} {H}_{i}^{( t ) T} {H}_{i}^{( t )} {η}^{( t )} + {ε}^{2} I )}^{- 1} ( \frac{1}{n} {\sum }_{i = 1}^{n} {α}_{i}^{( t )} {η}^{( t )} {H}_{i}^{( t ) T} {∇}_{z} {ϕ}_{i} ( h ( {w}^{( t )} ; i ) ) ) . \qquad ( 15 )$$

If ε² is small enough, then v_{*reg}^{(t)} is a close approximation of the solution v_{*}^{(t)} for problem (10). The first algorithm updates Framework 1 based on this approximation.

Lemma 2 below shows the relation between the regularized solution v_{*reg}^{(t)} and the optimal solution of the original convex problem v_{*ε}^{(t)}.

### Algorithm 1

Solve for the exact solution of the regularized problem:

Initialization: Choose an initial point w⁽⁰⁾ ∈ [symbol] ^{d}, tolerance ε>0; for t=0, 1, . . . , T−1 do
Update the search direction v^{(t)} as the solution v_{*reg}^{(t)} of problem in (14):

$${v}^{( t )} = {v}_{* reg}^{( t )} = {( \frac{1}{n} {\sum }_{i = 1}^{n} {η}^{( t )} {H}_{i}^{( t ) T} {H}_{i}^{( t )} {η}^{( t )} + {ε}^{2} I )}^{- 1} ( \frac{1}{n} {\sum }_{i = 1}^{n} {α}_{i}^{( t )} {η}^{( t )} {H}_{i}^{( t ) T} {∇}_{z} {ϕ}_{i} ( h ( {w}^{( t )} ; i ) ) )$$

Update w^{(t+1)}=w^{(t)}−η^{(t)}v^{(t)}
   end for Lemma 2: For given ε>0, suppose that Assumption 3 holds for bound V>0. Then, for iteration 0≤t<T, the optimal solution v_{*reg}^{(t)} of problem (14) satisfies ∥v_{*reg}^{(t)}∥²≤2+V and

$$\frac{1}{2} \frac{1}{n} {\sum }_{i = 1}^{n} {‖ {η}^{( t )} {H}_{i}^{( t )} {v}_{* reg}^{( t )} - {α}_{i}^{( t )} {∇}_{z} {ϕ}_{i} ( h ( {w}^{( t )} ; i ) ) ‖}^{2} \leq ( 1 + \frac{V}{2} ) {ε}^{2} . \qquad ( 16 )$$

Based on Lemma 2, the convergence to a global solution of Algorithm 1 is guaranteed and the first theorem is proven. Since it is currently expensive to solve for the exact solution of problem (14), the disclosed algorithm serves as a theoretical method to obtain the convergence to a global solution for the finite-sum minimization. It is noted that ε represents a desired accuracy. While a non-limiting example is 0.0001, the skilled artisan would understand how to heuristically select ε depending on the domain and the desired accuracy).

### Theorem 1

Let w^{(t)} be generated by Algorithm 1 where the closed form solution is used for the search direction. Algorithm 1 is executed for

$$T = \frac{β}{ε}$$

outer loops for some constant β>0. Assumption 1 is assumed to hold. Suppose that Assumption 2 holds for G>0 and Assumption 3 holds for V>0 . The step size is set to equal to η^{(t)}=D\sqrt{ε} for some D>0 and a learning rate αᵢ^{(t)}=(1+ε)αᵢ^{(t-1})=(1+ε)^{t}αᵢ⁽⁰⁾ is chosen. Based on β,

$${α}_{i}^{( 0 )} = \frac{α}{{e}^{β} {L}_{ϕ}}$$

is defined with α ∈ (0, ⅓). Let F_{*} be the global minimizer of F, and h*ᵢ= [symbol] . Then

$$\frac{1}{T} {\sum }_{t = O}^{T - 1} [ F ( {w}^{( t )} ) - {F}_{*} ] \leq \frac{{e}^{β} {L}_{ϕ} ( 1 + ε )}{2 ( 1 - 3 α ) α β} \cdot \frac{1}{n} {\sum }_{i = 1}^{n} {‖ h ( {w}^{( 0 )} ; i ) - {h}_{i}^{*} ‖}^{2} \cdot ε + \frac{{e}^{β} {L}_{ϕ} ( 3 ε + 2 )}{8 α ( 1 - 3 α )} [ {c ( 4 + ( V + 2 ) {GD}^{2} )}^{2} + 8 + 4 V ] \cdot ε . \qquad ( 17 )$$

It is noted that β is a constant for the purpose of choosing the number of iterations T. The analysis can be simplified by choosing β=1 with

$$T = \frac{1}{ε} .$$

Notice that the common convergence criteria for finding a stationary point for non-convex problems is

$$\frac{1}{T} {\sum }_{t = 1}^{T} {‖ ∇ F ( {w}_{t} ) ‖}^{2} \leq O ( ε ) .$$

This criteria has been widely used in the existing literature for non-convex optimization problems. The convergence criteria

$$\frac{1}{T} {Σ}_{t = 1}^{T} [ F ( {w}_{t} ) - {F}_{*} ] < O ( ε )$$

is slightly different, in order to find a global solution for non-convex problems.

The disclosed proof for Theorem 1 is novel and insightful. It is originally motivated by the Gradient Descent update (7) and the convexity of the loss functions ϕᵢ. For this reason, Algorithm 1 can find an ε-global solution after [symbol] (1/ε) iterations. However, computing the exact solution in every iteration might be extremely challenging, especially when the number of samples n is large. Therefore, a different approach to this problem is presented below.

### Approximation using Gradient Descent

In this section, the Gradient Descent (GD) algorithm is used to solve the strongly convex problem (14). If

$$ψ ( x ) - \frac{μ}{2} {‖ x ‖}^{2}$$

is convex for ∀x ∈ [symbol] ^{c}, then ψ(x) is μ-strongly convex. Hence, Ψ(⋅) is ε²-strongly convex. For each iteration t, GD is used to find a search direction v^{(t)} which is sufficiently close to the optimal solution v_{*reg}^{(t)} in that ∥v^{(t)}−v_{*reg}^{(t)}∥≤ε. The disclosed Algorithm 2 is described as follows.

### Algorithm 2: Solve the Regularized Problem Using Gradient Descent

Initialization: Choose an initial point w⁽⁰⁾ ∈ [symbol] ^{d}, tolerance ε>0; for t=0, 1, . . . , T−1 do
   Use Gradient Descent algorithm to solve Problem (14) and find a solution v(t) that

satisfies ∥v^{(t)}−v_{*reg}^{(t)}∥≤ε. (18)
Update w^{(t+1)}=w^{(t)}−η^{(t)}v^{(t)}
end for

Since Algorithm 2 can only approximate a solution within some ε-preciseness, a supplemental assumption is needed for the analysis of the next disclosed Theorem 2:

Assumption 4: Let Hᵢ^{(t)} be the Jacobian matrix defined in Lemma 1. It is assumed that there exists some constant H>0 such that, for i 531 [n], ε>0, and 0≤t<T as in Algorithm 2,

$$‖ {H}_{i}^{( t )} ‖ \leq \frac{H}{\sqrt{ε}} . \qquad ( 19 )$$

Assumption 4 requires a mild condition on the bounded Jacobian of h(w; i), and the upper bound may depend on ε. This flexibility allows the accommodation of a good dependence of ε for the theoretical analysis. The convergence theorem for Algorithm 2 is presented below.

### Theorem 2

Let w^{(t)} be generated by Algorithm 2 where v^{(t)} satisfies (18). Algorithm 2 is executed for

$$T = \frac{β}{ε}$$

outer loops for some constant β>0. Assumption 1 is assumed to hold. Suppose that Assumption 2 holds for G>0, Assumption 3 holds for V>0 and Assumption 4 holds for H>0. The step size is set equal to η^{(t)}=D\sqrt{ε} for some D>0 and a learning rate αᵢ^{(t)}=(1+ε)αᵢ^{(t-1)}=(1+ε)^{t}αᵢ⁽⁰⁾ is chosen. Based on β, ne

$${α}_{i}^{( 0 )} = \frac{α}{{e}^{β} {L}_{ϕ}}$$

with α ∈ 4,¼). Let F_{*} be the global minimizer of F, and h*ᵢ= [symbol] Then

$$\frac{1}{T} {\sum }_{t = 0}^{T - 1} [ F ( {w}^{( t )} ) - {F}_{*} ] \leq \frac{{e}^{β} {L}_{ϕ} ( 1 + ε )}{2 ( 1 - 4 α ) α β} \cdot \frac{1}{n} {\sum }_{i = 1}^{n} {‖ h ( {w}^{( 0 )} ; i ) - {h}_{i}^{*} ‖}^{2} \cdot ε + \frac{{e}^{β} {L}_{ϕ} ( 4 ε + 3 )}{2 α ( 1 - 4 α )} [ {D}^{2} {H}^{2} + {c ( 2 + ( V + {ε}^{2} + 2 ) G {D}^{2} )}^{2} + 2 + V ] \cdot ε .$$

Theorem 2 implies Corollary 2 which provides the computational complexity for Algorithm 2. Note that for (Stochastic) Gradient Descent, the complexity is derived in terms of component gradient calculations for the finite-sum problem (1). As an alternative, for Algorithm 2, the number of component gradients in problem (14) is compared where

$${Φ}^{( t )} ( v ) = \frac{1}{n} {Σ}_{i = 1}^{n} {ψ}_{i}^{( t )} ( v ) .$$

Such an individual gradient has the following form:

∇ᵥψᵢ^{(t)}(v)=η^{(t)}Hᵢ^{(t)T}Hᵢ^{(t)}η^{(t)}v−αᵢ^{(t)}η^{(t)}Hᵢ^{(t)T}∇_{z}ϕᵢ(h(w^{(t)};i)).

In machine learning applications, the gradient of f(⋅;i) is calculated using automatic differentiation (i.e., backpropagation). Since f(⋅;i) is the composition of the network structure h(⋅;i) and loss function ϕᵢ(⋅), this process also computes the Jacobian matrix Hᵢ^{(t)} and the gradient ∇_{z}ϕᵢ(h(w^{(t)};i)) at a specific weight w^{(t)}. Since matrix-vector multiplication computation is not expensive, the cost for computing the component gradient of problem (14) is similar to problem (1).

Corollary 2: Suppose that the conditions in Theorem 2 hold with

$${η}^{( t )} = \frac{D \sqrt{ε}}{\sqrt{N}}$$

for some D>0 and 0<\hat{ε}≤N (that is, we set ε=\hat{ε}/N, where

$$N = \frac{{e}^{β} {L}_{ϕ} {Σ}_{i = 1}^{n} {‖ h ( {w}^{( 0 )} ; i ) - {h}_{i}^{*} ‖}^{2}}{n ( 1 - 4 α ) α β} + \frac{7 {e}^{β} {L}_{ϕ} [ {D}^{2} {H}^{2} + {c ( 2 + ( V + 3 ) G {D}^{2} )}^{2} + 2 + V ]}{2 α ( 1 - 4 α )} .$$

Then, the total complexity to guarantee

$${min}_{0 \leq t \leq T - 1} [ F ( {w}^{( t )} ) - {F}_{*} ] \leq \frac{1}{T} {\sum }_{t = 0}^{T - 1} [ F ( {w}^{( t )} ) - {F}_{*} ] \leq \hat{ε}$$

$$is 𝒪 ( n \frac{{N}^{3} β}{{\hat{ε}}^{3}} ( {D}^{2} {H}^{2} + ( {\hat{ε}}^{2} / N ) ) log ( \frac{N}{\hat{ε}} ) ) .$$

Remark 1: In total, Algorithm 2 has total complexity

$$𝒪 ( \frac{n}{{\hat{ε}}^{3}} log ( \frac{1}{\hat{ε}} ) )$$

for finding an \hat{ε}-global solution. For a comparison, Stochastic Gradient Descent uses a total of [symbol] (1/ε²) gradient computations to find a stationary point satisfying [symbol] [∥∇F(ŵ)∥²]≤ε for non-convex problems. Gradient Descent has a better complexity in terms of ε, i.e., [symbol] (n/ε) such that ∥∇F(ŵ)∥²≤ε.

In order to guarantee global convergence for nonconvex settings, the Polyak-Lojasiewicz (PL) inequality can be employed.

### ILLUSTRATIVE EXAMPLES

Algorithm 1 was implemented, and the training progress is illustrated in FIG. 2 along with the GD and SGD algorithms. Algorithm 2 performs relatively similarly to Algorithm 1 in experiments (their plots are omitted because the computational cost per iteration of Algorithm 2 is not comparable to GD and SGD algorithms). In FIG. 2, curve 1099 is for Algorithm 1 according to aspects of the invention, curve 1097 is for GD, and curve 1095 is for SGD.

FIG. 2 thus illustrates a comparison of Algorithm 1 versus GD and SGD algorithms, in accordance with an example embodiment. The step size was tuned using grid search and trained using the best value. To make a fair comparison to GD, the SGD algorithm is plotted for every full data pass, which yields the same computational cost as an iteration of GD. For an exemplary embodiment, the cost is approximately a full gradient computation (plus an inverse operator) per iteration.

For the first problem, the squared loss ϕᵢ(h(w;i))=½∥(h(w;i))−y⁽ⁱ⁾∥² is considered with a simple network h(w;i)=σ(w₁^{T}x⁽ⁱ⁾)+w₂, where w=(w₁, w₂) ∈ [symbol] ¹⁰ are the parameters, and σ=log(1+exp(βx))/β is the Softplus function (i.e. a smoothed version of ReLU (rectified linear unit) activation). For Problem 2, a slightly different network h(w;i)=w₂σ(w₁^{T}x⁽ⁱ⁾) is considered, where w=(w₁, w₂) ∈ [symbol] ¹⁰ with squared loss. In both problems, the input data {x⁽ⁱ⁾}ᵢ₌₁¹⁰⁰ ∈ [symbol] ⁵ are fixed and randomly chosen. In order to match the over-parameterized settings, the output data {y⁽ⁱ⁾} ∈ [symbol] ⁵ are chosen such that the objective function attains its global minimum value at 0. All three algorithms were run starting from 10 fixed random points; we found in our experiments that Algorithm 1 is able to find the global solution after a few iterations.

Thus, it will be appreciated that an alternative composite formulation for solving the finite-sum optimization problem has been disclosed herein. Embodiments of the disclosed formulation allow a new way of exploiting the structure of machine learning problems and lead to a novel algorithmic framework that guarantees convergence to a global solution (when the outer loss functions are convex and Lipschitz-smooth). Embodiments of the disclosed analysis are general and can be applied to various different learning architectures; in particular, the disclosed settings and assumptions match practical neural networks. Algorithm 2 demonstrates a gradient method to solve the regularized problem; however, other methods can be applied to the disclosed framework (e.g., conjugate gradient descent). The disclosed theoretical foundation motivates further implementation and optimization of the new algorithmic framework and consideration of its non-standard bounded style assumptions. Neural networks trained using the disclosed framework and associated algorithms may be used for many different deep learning applications, such as classification, regression, and the like. Non-limiting specific examples include image classification, natural language processing, computer vision, object identification, and the like. The trained neural networks may be used, for example, to control industrial robots, perform autonomous driving, and the like. For example, software control can be carried out by a processor (set) 110 communicating with a robot or vehicle over a network 102 as discussed below, through hard-wired communication, or the like.

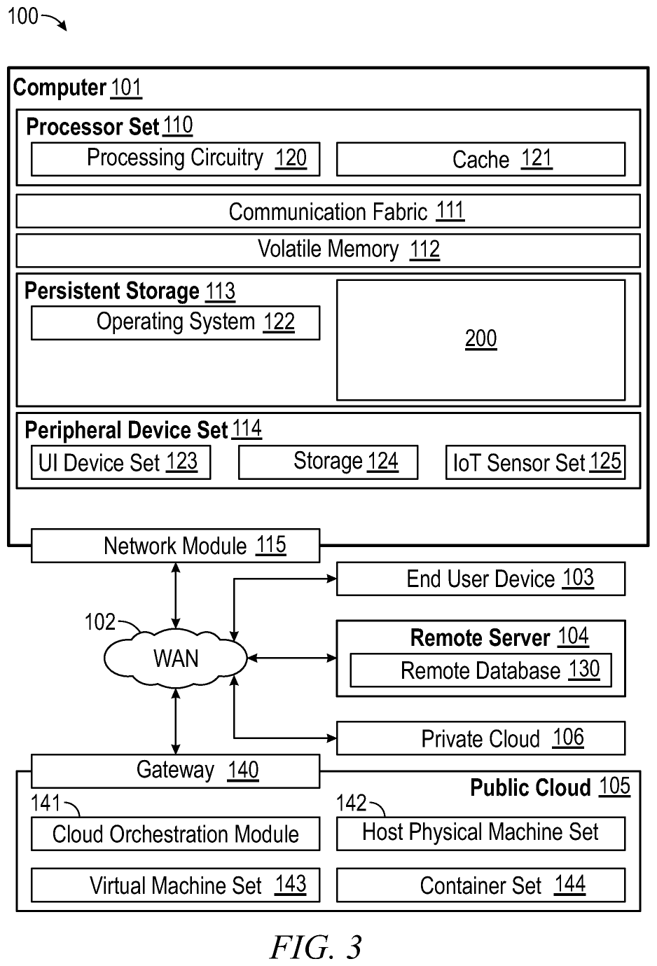

Given the discussion thus far, it will be appreciated that, in general terms, an exemplary method, according to an aspect of the invention, includes selecting an initial weight vector w⁽⁰⁾ for a convex optimization sub-problem (Eq. (10)) associated with a neural network having a non-convex network architecture loss surface (problem of Eq. (1)). In a non-limiting example, the neural network can be a deep neural network, but this is not a requirement in all cases. The method further includes, with at least one processor (see discussion of FIG. 3), approximating a solution to the convex optimization sub-problem that obtains a search direction, to learn a common classifier from training data. The approximate solution to the convex optimization sub-problem is referred to herein as v^{(t)}, while the exact solution to the convex optimization sub-problem is referred to herein as v_{*}^{(t)}. Refer to Framework 1. The method still further includes, with the at least one processor, updating the initial weight vector by subtracting the approximate solution to the convex optimization sub-problem times a first learning rate (w^{(t+1)}=w^{(t)}−η^{(t)}v^{(t)}). The method even further includes, with the at least one processor, repeating the approximating and updating steps, for a plurality of iterations (e.g., t=0, . . . , T-1), with the updated weight vector from a given one of the iterations taken as the initial weight vector for a next one of the iterations, to obtain a final weight vector for the neural network, until convergence to a global minimum is achieved, to implement the common classifier.

It is worth noting that the optimization problem (Eq. (1)) for training neural networks is non-convex. One or more embodiments formulate another convex sub-problem to update the weights. This convex sub-problem is different from the non-convex problem. That is to say, the optimization problem in (Eq. (1)) is non-convex - and this is the training neural network problem by solving the optimization problem in (Eq. (1)). In order to solve the problem in (Eq. (1)), one or more embodiments advantageously provide a new method by constructing the (sub) problem (Eq. (10)) and creating Framework 1. This (sub) problem (Eq. (10)) is convex. The reason why it is referred to as a “sub”-problem is because in Framework 1, there are T iterations (t=0, . . . , T-1), and for every iteration t, the convex (sub) problem (Eq. (10)) is solved.

One or more embodiments further include carrying out inferencing with the computerized neural network having the final weight vector. In a non-limiting example, the inferencing includes image classification, it being understood that one or more embodiments have many different practical applications such as other machine learning tasks, e.g., pattern recognition, neural network training, and the like.

Image classification (or other applications) could be used, for example, to control an industrial robot, automatically drive an autonomous vehicle, and the like.

Considering Framework 1, in one or more embodiments, the convex optimization sub-problem that obtains the search direction includes minimizing an expression including an average (note the terms ½ and 1/n before the summation in Framework 1), over the training data, of a squared norm of a difference between a first term and a second term, the first term (η^{(t)}Hᵢ^{(t)}v) including the first learning rate times a first order derivative matrix times the approximate solution, the second term (αᵢ^{(t)}∇_{z}ϕᵢ(h(w^{(t)};i))) including a second learning rate times a gradient of a loss function.

In one or more embodiments, the expression is given by

$${v}_{*}^{( t )} = arg {min}_{v ∈ {ℝ}^{d}} \{ \frac{1}{2} \frac{1}{n} {\sum }_{i = 1}^{n} {‖ {η}^{( t )} {H}_{i}^{( t )} v - {α}_{i}^{( t )} {∇}_{z} {ϕ}_{i} ( h ( {w}^{( t )} ; i ) ) ‖}^{2} \} ,$$

wherein a total number of the plurality of iterations is defined by T time steps t, Hᵢ^{(t)} includes the first order derivative matrix, η^{(t)}>0 is the first learning rate, v^{(t)} is the approximate solution for the search direction, w^{(t)} is the weight vector at time t, aᵢ^{(t)} is the second learning rate, Δ_{z} is the gradient, ϕᵢ is the loss function, h(⋅;i) is the classifier neural network, v_{*}^{(t)} is the exact solution for the search direction, and n is a count of training samples.

Considering Algorithm 1, in one or more embodiments, approximating the solution to the convex optimization problem that obtains the search direction includes obtaining an exact solution to a regularized form of the convex optimization sub-problem. For example, in one or more such embodiments, the exact solution to the regularized form of the convex optimization sub-problem is given by:

$${v}_{* reg}^{( t )} = {( \frac{1}{n} {\sum }_{i = 1}^{n} {η}^{( t )} {H}_{i}^{( t ) T} {H}_{i}^{( t )} {η}^{( t )} + {ε}^{2} I )}^{- 1} ( \frac{1}{n} {\sum }_{i = 1}^{n} {α}_{i}^{( t )} {η}^{( t )} {H}_{i}^{( t ) T} {∇}_{z} {ϕ}_{i} ( h ( {w}^{( t )} ; i ) ) )$$

wherein Hᵢ^{(t)} includes the first order derivative matrix, η^{(t)}>0 is the first learning rate, w^{(t)} is the weight vector at time t, αᵢ^{(t)} is the second learning rate, ∇_{z} is the gradient, ϕᵢ is the loss function, h(⋅;i) is the classifier neural network, n is a count of training samples, ε is a predetermined tolerance and I is an identity matrix.

Referring to Assumptions 2 and 3, for example, in one or more embodiments, h(⋅;i) is twice continuously differentiable for all i ∈ [n] and a problem dimension d is sufficiently large to interpolate all the data and the tolerance ε.

Considering Algorithm 2, in one or more embodiments, approximating the solution to the convex optimization sub-problem that obtains the search direction includes applying gradient descent such that a norm of a difference between the approximate solution and a solution to a regularized form of the convex optimization problem does not exceed a predetermined tolerance ε. For example, the tolerance here and for the regularizer can be determined heuristically by the skilled artisan, given the teachings herein, for the desired domain and degree of accuracy e.g., 0.0001. In one or more such embodiments, h(⋅;i) is the classifier neural network and h(⋅;i) is twice continuously differentiable for all i ∈ [n]; and a problem dimension d is sufficiently large to interpolate all the data and the tolerance ε.

Aspects of the invention can be implemented, for example, by software, written in a high-level language, implementing the equations and logic set forth herein, compiled into executable code, and executed on one or more hardware processors. Hardware acceleration could also be employed in some cases, as appropriate.

In another aspect, a non-transitory computer readable medium includes computer executable instructions which when executed by a computer cause the computer to perform any one, some, or all of the method steps just described. See, e.g., FIG. 3 and accompanying text.

In still another aspect, an exemplary apparatus includes a memory; and at least one processor, coupled to the memory, and operative to perform any one, some, or all of the method steps just described. See, e.g., FIG. 3 and accompanying text.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Refer now to FIG. 3.

Computing environment 100 contains an example of an environment for the execution of at least some of the computer code involved in performing the inventive methods, such as training models as described herein and/or deploying and running the trained models, as seen at 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 3. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments of the invention, or elements thereof, can thus be implemented in the form of an apparatus including a memory and at least one processor that is coupled to the memory and operative to perform exemplary method steps. FIG. 3 depicts a computer system that may be useful in implementing one or more aspects and/or elements of the invention

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
selecting an initial weight vector for a convex optimization sub-problem associated with a neural network having a non-convex network architecture loss surface;
with at least one processor, approximating a solution to the convex optimization sub-problem that obtains a search direction, to learn a common classifier from training data;
with the at least one processor, updating the initial weight vector by subtracting the approximate solution to the convex optimization sub-problem times a first learning rate; and
with the at least one processor, repeating the approximating and updating steps, for a plurality of iterations, with the updated weight vector from a given one of the iterations taken as the initial weight vector for a next one of the iterations, to obtain a final weight vector for the neural network, until convergence to a global minimum is achieved, to implement the common classifier.

2. The method of claim 1, further comprising carrying out inferencing with the neural network having the final weight vector.

3. The method of claim 2, wherein the inferencing comprises image classification.

4. The method of claim 3, further comprising controlling an industrial robot based on the image classification.

5. The method of claim 3, further comprising performing automatically driving an autonomous vehicle based on the image classifications.

6. The method of claim 1, wherein the convex optimization sub-problem that obtains the search direction comprises minimizing an expression including an average, over the training data, of a squared norm of a difference between a first term and a second term, the first term comprising the first learning rate times a first order derivative matrix times the approximate solution, the second term comprising a second learning rate times a gradient of a loss function.

7. The method of claim 6, wherein the expression comprises:
$${v}_{*}^{( t )} = arg {min}_{v ∈ {ℝ}^{d}} \{ \frac{1}{2} \frac{1}{n} {\sum }_{i = 1}^{n} {‖ {η}^{( t )} {H}_{i}^{( t )} v - {α}_{i}^{( t )} {∇}_{z} {ϕ}_{i} ( h ( {w}^{( t )} ; i ) ) ‖}^{2} \} ,$$
wherein a total number of the plurality of iterations is defined by T time steps t, Hᵢ^{(t)} comprises the first order derivative matrix, η^{(t)}>0 is the first learning rate, v^{(t)} is the approximate solution for the search direction, w^{(t)} is the weight vector at time t, αᵢ^{(t)} is the second learning rate, ∇_{z} is the gradient, ϕᵢ is the loss function, h(⋅;i) is the classifier neural network, v_{*}^{(t)} is the exact solution for the search direction, and n is a count of training samples.

8. The method of claim 6, wherein approximating the solution to the convex optimization problem that obtains the search direction comprises obtaining an exact solution to a regularized form of the convex optimization sub-problem.

9. The method of claim 8, wherein the exact solution to the regularized form of the convex optimization sub-problem is given by:
$${v}_{* reg}^{( t )} = {( \frac{1}{n} {{\sum }_{i = 1}}^{n} {η}^{( t )} {H}_{i}^{( t ) T} {H}_{i}^{( t )} {η}^{( t )} + {ε}^{2} I )}^{- 1} ( \frac{1}{n} {\sum }_{i = 1}^{n} {α}_{i}^{( t )} {η}^{( t )} {H}_{i}^{( t ) T} {∇}_{z} {ϕ}_{i} ( h ( {w}^{( t )} ; i ) ) )$$
wherein Hᵢ^{(t)} comprises the first order derivative matrix, η^{(t)}>0 is the first learning rate, w^{(t)} is the weight vector at time t, αᵢ^{(t)} is the second learning rate, ∇_{z} is the gradient, ϕᵢ is the loss function, h(⋅;i) is the classifier neural network, n is a count of training samples, ε is a predetermined tolerance and I is an identity matrix.

10. The method of claim 9, wherein h(⋅;i) is twice continuously differentiable for all i ∈ [n] and a problem dimension d is sufficiently large to interpolate all the data and the tolerance ε.

11. The method of claim 6, wherein:
approximating the solution to the convex optimization sub-problem that obtains the search direction comprises applying gradient descent such that a norm of a difference between the approximate solution and a solution to a regularized form of the convex optimization problem does not exceed a predetermined tolerance ε;
h(⋅;i) is the classifier neural network and h(⋅;i) is twice continuously differentiable for all i ∈ [n]; and
a problem dimension d is sufficiently large to interpolate all the data and the tolerance ε.

12. A computer program product, the computer program product comprising a computer readable storage medium having program instructions embodied therewith, the program instructions executable by a processor to cause the processor to:
obtain a selection of an initial weight vector for a convex optimization sub-problem associated with a neural network having a non-convex network architecture loss surface;
approximate a solution to the convex optimization sub-problem that obtains a search direction, to learn a common classifier from training data;
update the initial weight vector by subtracting the approximate solution to the convex optimization sub-problem times a first learning rate; and
repeat the approximating and updating steps, for a plurality of iterations, with the updated weight vector from a given one of the iterations taken as the initial weight vector for a next one of the iterations, to obtain a final weight vector for the neural network, until convergence to a global minimum is achieved, to implement the common classifier.

13. The computer program product of claim 12, wherein the program instructions are further executable by the processor to cause the processor to carry out inferencing with the neural network having the final weight vector.

14. The computer program product of claim 13, wherein the inferencing comprises image classification.

15. An apparatus comprising:
a memory; and
at least one processor, coupled to the memory, and operative to:
obtain a selection of an initial weight vector for a convex optimization sub-problem associated with a neural network having a non-convex network architecture loss surface;
approximate a solution to the convex optimization sub-problem that obtains a search direction, to learn a common classifier from training data;
update the initial weight vector by subtracting the approximate solution to the convex optimization sub-problem times a first learning rate; and
repeat the approximating and updating steps, for a plurality of iterations, with the updated weight vector from a given one of the iterations taken as the initial weight vector for a next one of the iterations, to obtain a final weight vector for the neural network, until convergence to a global minimum is achieved, to implement the common classifier.

16. The apparatus of claim 15, wherein the at least one processor is further operative to carry out inferencing with the neural network having the final weight vector.

17. The apparatus of claim 16, wherein the inferencing comprises image classification, and wherein the at least one processor is further operative to control an industrial robot based on the image classification.

18. The apparatus of claim 15, wherein the convex optimization sub-problem that obtains the search direction comprises minimizing an expression including an average, over the training data, of a squared norm of a difference between a first term and a second term, the first term comprising the first learning rate times a first order derivative matrix times the approximate solution, the second term comprising a second learning rate times a gradient of a loss function.

19. The apparatus of claim 18, wherein the at least one processor is operative to approximate the solution to the convex optimization problem that obtains the search direction by obtaining an exact solution to a regularized form of the convex optimization sub-problem.

20. The apparatus of claim 18, wherein the at least one processor is operative to approximate the solution to the convex optimization problem that obtains the search direction by applying gradient descent such that a norm of a difference between the approximate solution and a solution to a regularized form of the convex optimization problem does not exceed a predetermined tolerance.
